(19) United States
(12) Patent Application Publication
(10) Pub. No.: US 2009/0194135 A1
(43) Pub. Date: Aug. 6, 2009

(54) Wallet size oral hygiene product

(76) Inventor: Shaul Ezer, North York (CA)

Correspondence Address: Shaul Ezer, 1407-55 Wynford Heights Crescent, North York, ON, M3C 1L5, CA

(21) Appl. No.: 12/319,811

(22) Filed: Jan. 13, 2009

(30) Foreign Application Priority Data
Feb. 4, 2008 (CA) 2615826

(51) Int. Cl. A61C 15/02

(52) U.S. Cl. 132/329

(57) ABSTRACT

An oral hygiene product is disclosed. More specifically, the product is a rubbery tip toothpick. Such product is commonly known as gum massager or gum stimulator. The disclosed toothpick having a rigid rod and at least one end having a rubbery tip. The rod is fabricated from rigid plastic such as Polypropylene. The tip is fabricated from rubbery plastic such as Thermoplastic Elastomer thermally joined together with the rigid rod using a process such as injection molding. The tip is fabricated in the general shape of a cone with its main axis at an angle of less than 180° with respect to the main axis of said rod. A gum stimulator fabricated this way is safer to use, more effective, and more portable than prior art of gum stimulators.

### CROSS REFERENCE TO RELATED APPLICATION

This application claims foreign priority to Canada Application No. 2615826 filed on Feb. 4, 2008 entitled “Wallet size oral hygiene product”.

### FIELD OF THE INVENTION

The invention relates to an apparatus for use in performing oral hygiene. More specifically, the invention is a rubbery tip toothpick commonly known as gum massager or gum stimulator.

### BACKGROUND TO THE INVENTION

Current technology of fabricating a gum stimulator is to mechanically mount a rubbery tip on a rigid rod. There is an abundance of gum stimulators that are fabricated this way. For example, John Butler Company, a division of Sunstar Americas of Chicago Ill. fabricates a gum stimulator made of a brass plated aluminum rod with a rubbery tip mechanically mounted on one end. Oral-B, a division of The Procter & Gamble Company, P.O. Box 599 Cincinnati, Ohio 45201-5572 fabricates a gum stimulator made of a rigid plastic rod with a rubbery tip mechanically mounted on one end. Dental Concepts, Irvington, N.Y. 10533 fabricates a gum stimulator made of a rigid plastic rod with rubbery tips mechanically mounted on both ends under the brand name Doctor's.

The prior art gum stimulator offers the user the convenience of requiring a single gum stimulator purchase and when the rubbery tip loses its effectiveness the user needs only to buy the replacement tips. However, a replaceable rubbery tip is generally not firmly attached with the consequence that the tip may wobble and become unmanageable, or become dislodged and may be swallowed by the user. In severe cases infants may experience choking on misplaced tips. Also, the mechanical mount for the replaceable tip is generally bulky which makes the gum stimulator too thick for storage in the user's wallet. Furthermore, a gum stimulator with a mechanically mounted tip has an awkward geometry that forces the user to open the mouth extremely wide when trying to reach the gum line of the front teeth on the tongue side.

### SUMMARY OF THE INVENTION

The present invention provides a toothpick with a rigid plastic rod having a rubbery tip thermally molded therewith. The elasticity of the tip allows for gentle cleaning between the teeth and stimulating the gums while the rigidity of the rod provides the means for manipulating the tip. A toothpick fabricated this way is safer to use than prior art and, when made from recyclable materials, it is also environmentally friendly. Furthermore, a toothpick fabricated this way is small enough to store in a wallet and be available to the user at all times. An advantage of the present invention is the ability to provide a short curved portion of the toothpick so that the tip can easily reach the gum line of the front teeth on the tongue side without forcing the user to open an extremely wide mouth. The present invention also facilitates easy access to the gum line along the back teeth.

In view of the forgoing, the present invention provides a toothpick comprising a rod formed from rigid plastic such as Polypropylene, having a gripping portion and a curved portion extending from the gripping portion. The curved portion terminates at a base such that the base has an obtuse angle alignment towards the gripping portion. A tip formed from rubbery plastic such as Thermoplastic Elastomer thermally joined to the rigid rod at the base. The tip providing elastic surfaces for cleaning and stimulating the gums and the rigid rod providing the means for manipulating said tip.

### BRIEF DESCRIPTION OF THE DRAWINGS

The skilled person in the art will understand that the figures, described below, are for illustration purpose only.

In the accompanying figures where like reference numerals represent like parts:

FIG. 1 is a graphical representation side view of the toothpick according to an embodiment of the present invention; and

FIG. 2 is a graphical representation side view of the toothpick according to another embodiment of the present invention.

### DETAILED DESCRIPTION OF THE VARIOUS EMBODIMENTS

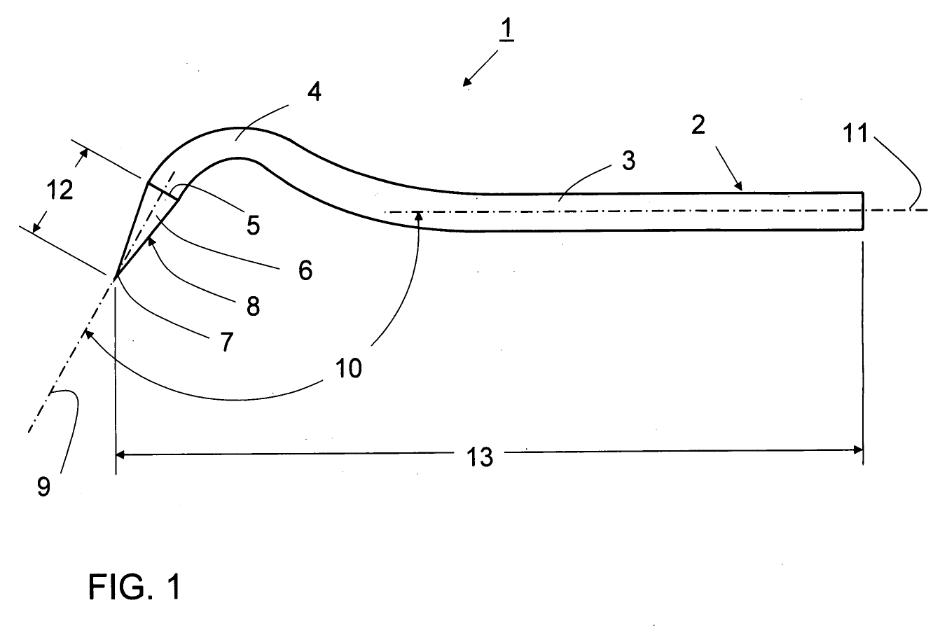

Reference is first made to FIG. 1 which illustrates a toothpick (1) fabricated from a rod (2). The rod (2) comprises a gripping portion (3) and a curved portion (4) that generally extends from the gripping portion (3). The curved portion (4) terminates at a base (5). A tip (6) thermally formed, extending from the base and being tapered in configuration from the base (5) towards its end (7). The embodiment of the tip (6) is a general shape of a cone (8). The main axis (9) of cone (8) forms an obtuse angle (10) with the mains axis (11) of the gripping portion (3). The angle (10) can thus be accomplished by fabricating the curved portion (4). In order to maintain the angle (10), the tip (6) and the curved portion (4) are joined thermally through a process such as injection molding.

To facilitate oral hygiene, the user would grasp the toothpick (1) along the gripping portion (3), insert the tip (6) between two adjacent teeth along the gum line and flick the tip (6) away from the gum line to remove food or plaque. When the cleaning is done, the user re-inserts the tip (6) between two adjacent teeth along the gum line and applies a circular motion around the main axis (9) of the tip (6) thereby; the rubbery surfaces of tip (6) massage the gums and increase blood circulation to stimulate the gums. The integrity of the angled alignment (10) of the tip (6) is maintained as the user applies sufficient pressure to the gum due to the physical property of the tip (6) as described below. Tip (6) is fabricated such that it is soft enough to prevent damage when it comes in contact with the gums; however, it is resilient enough to maintain its original shape for an extended use. With the general application of an injection molding process as known in the art, various forms of configurations for injection molding the Thermoplastic Elastomer over the rod material can be contemplated so that the tip (6) and rod (2) becomes permanently affixed. For example, the Polypropylene rod can be injection molded to form a configuration of ridges or radial protrusions at the base followed by injection molding the Thermoplastic Elastomer over this configuration. The thermally molded tip resulting in the two different materials securely bonded together having rigid but elastic surface properties.

The teachings of the present invention overcomes the disadvantages of the prior art. For example, the periodontal stimulator of U.S. Pat. No. 3,775,848 issued to Dr. M. Edward Barnett teaches a tapered “body member” and a “core member” ensheathed within the said “body member”, where the “core member” provides the grip and the “body member” is the portion that does the cleaning and stimulation of the gums. Barnett's device has the “body member” and the “core member” sharing the same axis, such axis forming a straight line, and the “core member” is bendable in all directions when the device encounters “hard” surfaces such as healthy gingival tissue. Barnett's “body member” is fabricated of a material which is deformable to enable said “body member” to conform to the configuration of spaces and tunnels between the lateral walls of adjacent teeth.

The present invention, unlike Barnett's device, has an obtuse angle (10) between the gripping portion (3) and the tip (6); such angle is essential in reaching interdental spaces at the back of the mouth and tongue side of the front teeth. The gripping member (3) of the current invention, unlike the Barnett's “core member”, does not require any bending to perform the cleaning and gum stimulation functions. On the contrary, the gripping member (3) can be rigid to facilitate proper manipulation of the current invention. Unlike Barnett's deformable “body member”, the tip (6) of the current invention is bendable to prevent irritation of the gums, but it does not deform to conform to the configuration of spaces and tunnels between lateral walls of adjacent teeth.

Other prior art dental cleaners such as the periodontal curet disclosed in Canada Patent No. 2,012,433 issued to Barbara Long, has a curved working tip for removing tarter from the root surface of a person's teeth. Since the tarter is a hard solid mass of calcified deposit, the working tip must necessary have a sharp and aggressive surface in order to perform a scraping action. Although the working tip is rigid, the sharp and aggressive nature of this curet is inappropriate as a gum stimulator.

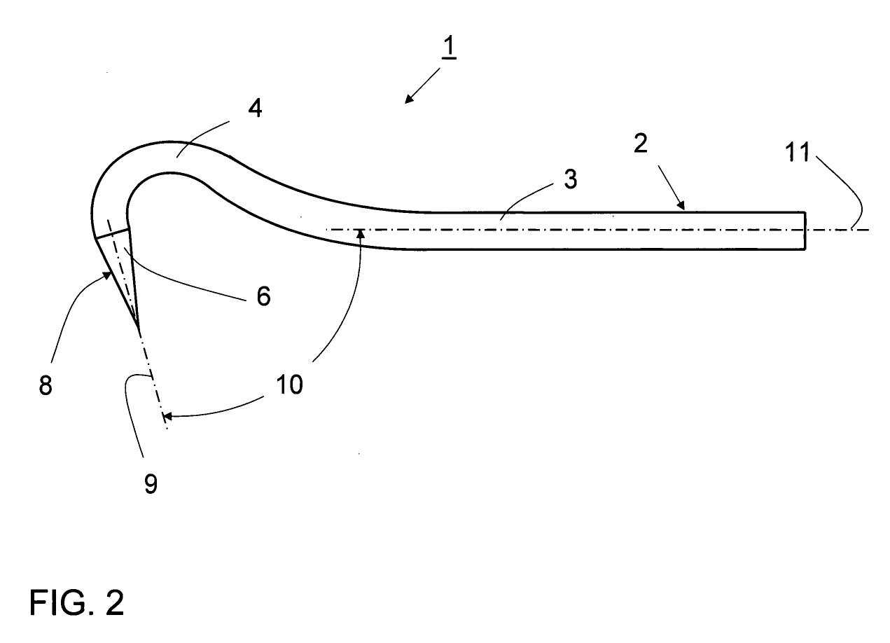

While the present teachings are described in conjunction with various embodiments, it is not intended that the present teaching be limited to such embodiments. On the contrary, the present teachings encompass various alternatives, modifications, and equivalents, as will be appreciated by those of skill in the art. For example, the present applicants recognize that the angle alignment (10) of the tip (6), as defined by the curved portion (4) of the toothpick (1) can be at an obtuse angle (less than 180° and greater than 90°) as in FIG. 1. Alternatively, the angle alignment (10) can be acute (less than 90°) as in FIG. 2, so to provide greater access to the gums along the front teeth on the tongue side. This acute angle geometry is similar to a “hook”, and it is because of the thermally formed elastically rigid tip (6), as described above, that enables this geometry to be practiced so to provide soft massaging properties while maintaining the rigidity of the angle alignment (10).

In various embodiments, the Thermoplastic Elastomer of the tip (6) and the rigid plastic of the rod (2) can be thermally molded together by a thermal process such as injection molding. With the general application of an injection molding process as known in the art, various forms of configurations for injection molding the Thermoplastic Elastomer over the rod material can be contemplated so that the tip (6) and rod (2) become permanently affixed. For example, the Polypropylene rod can be injection molded to form a configuration of ridges or radial protrusions at the base followed by injection molding the elastomer over this configuration. The thermally molded tip resulting in the two different materials securely bonded together having rigid but elastic surface properties.

In various embodiments, generally, the total length (13) of toothpick (1) and diameter of the base (4) of cone (8) can be sized appropriately so that the toothpick can be conveniently portable and fit in a wallet. For example, the total length (13) can be approximately 75 mm and the diameter of the base (4) can be approximately 4 mm while the height (12) of the tip (6) can be approximately 9 mm.

I claim:

1. A toothpick for use in performing oral hygiene operation comprising:
a rod having a gripping portion and a curved portion extending from the gripping portion, the curved portion terminating at a base such that the base having an angled alignment towards the gripping portion; and
a rigid tip thermally formed with the base for extending the angled alignment, the tip having an elastic surface for providing oral hygiene operation such that the tip remains rigid with the curved portion.

2. The toothpick according to claim 1, wherein the rod is rigid plastic.

3. The toothpick according to claim 2, wherein the thermally formed tip is a mold of rubber with the rigid plastic.

4. The toothpick according to claim 3, wherein the angled alignment is an obtuse angle between the base of the curved portion and the gripping portion.

5. The toothpick according to claim 3, wherein the angled alignment is an acute angle between the base of the curved portion and the gripping portion.
